(19) United States
(12) Patent Application Publication
(10) Pub. No.: US 2010/0133194 A1
(43) Pub. Date: Jun. 3, 2010

(54) WATER TREATMENT SYSTEMS WITH DUAL PURPOSE ION EXCHANGE RESIN

(75) Inventors: Roger Eric Johnson, Reno, NV (US); Sivarooban Theivendran, Reno, NV (US)

Correspondence Address: K&L GATES LLP, 210 SIXTH AVENUE, PITTSBURGH, PA, 15222-2613, US

(73) Assignee: Water Security Corporation, Sparks, NV (US)

(21) Appl. No.: 12/613,462

(22) Filed: Nov. 5, 2009

Related U.S. Application Data
(60) Provisional application No. 61/111,491, filed on Nov. 5, 2008.

(51) Int. Cl. C02F 1/42

(52) U.S. Cl. 210/662; 210/96.1

(57) ABSTRACT

A low pressure point-of-use water treatment system may generally comprise at least one inlet port in fluid communication with at least one outlet port to establish a fluid pathway therethrough; an iodinated resin intermediate the at least one inlet port and at least on outlet port, wherein the iodinated resin transfers iodine into the fluid pathway for a volume of water corresponding to an effective life of the iodinated resin; and an ion exchange resin intermediate the iodinated resin and the at least one outlet port, wherein the ion exchange resin removes at least a portion of the iodine transferred by the iodinated resin into the fluid pathway for a volume of water corresponding to a breakthrough point as measured by iodide leakage; and wherein the ion exchange resin inactivates contaminants in the fluid pathway as the iodinated resin nears the end of its effective life.

### CROSS-REFERENCE TO RELATED APPLICATIONS

This application claims the benefit under 35 U.S.C. §119(e) of U.S. Provisional Application No. 61/111,491, filed on Nov. 5, 2008, which is incorporated herein by reference in its entirety.

### BACKGROUND

The water treatment systems described herein generally relate to water treatment systems comprising halogenated resins and ion exchange resins as well as methods of making and using the same.

Over one billion people lack access to reliable and sufficient quantities of safe or potable drinking water. Waterborne contaminants may pose a critical health risk to the general public, including vulnerable populations, such as children, the elderly, and those afflicted with disease, if not removed from drinking water. An estimated six million people die each year, half of which are children under 5 years of age, from contaminated drinking water. The U.S. Environmental Protection Agency Science Advisory Board considers contaminated drinking water one of the public's greatest health risks.

Water treatment systems including halogenated release systems have been successfully used to remove contaminants from water and other fluids. Halogenated release systems may include halogenated resins that release halogens, e.g., chlorine, iodine, and bromine, into the fluid passing therethrough. The amount of halogen released into the fluid may be capable of removing contaminants upon contact between the halogen and contaminants. Water treatment systems including halogenated release systems generally remain effective as long as the halogenated release system continues to release an effective amount of halogen into the fluid.

The filtration capacity of water treatment systems may refer to the predetermined volume of water correlating to a minimum safe volume of water that the halogenated release system is capable of treating under the harshest predicted operating environment. Accepted wisdom in the art suggests that the filtration capacity of the water treatment systems generally correspond to the effective life of the halogenated release system. Therefore, when the halogenated release system reaches its effective life, i.e., the halogenated release system is no longer releasing an effective amount of halogen into the fluid, at least the halogenated release system should be replaced. This may be problematic, however, because frequently replacing the halogenated release system may increase the cost and/or decrease the efficiency water treatment systems.

Therefore, more efficient and/or cost-effective water treatment systems and methods of making and using the same are desirable.

### SUMMARY

In certain embodiments, more efficient and/or cost-effective water treatment systems and methods of making and using the same are described.

According to certain embodiments, a low pressure point-of-use water treatment system may generally comprise at least one inlet port in fluid communication with at least one outlet port to define a fluid pathway therethrough an iodinated resin intermediate the at least one inlet port and the at least one outlet port, wherein the iodinated resin transfers iodine into the fluid pathway for a volume of water corresponding to an effective life of the iodinated resin; and an ion exchange resin intermediate the iodinated resin and the at least one outlet port, wherein the ion exchange resin removes at least a portion of the iodine transferred by the iodinated resin into the fluid pathway for a volume of water corresponding to a breakthrough point as measured by iodide leakage; and wherein the ion exchange resin inactivates contaminants in the fluid pathway as the iodinated resin nears the end of its effective life.

According to certain embodiments, a method may generally comprise providing a low pressure point-of-use water treatment system having a microbial inactivation capacity, the water treatment system comprising at least one inlet port in fluid communication with at least one outlet port to define a fluid pathway therethrough, an iodinated resin intermediate the at least one inlet port and the at least one outlet port, and an ion exchange resin intermediate the iodinated resin and the at least one outlet port; introducing water into the at least one inlet port; passing a first volume of water through the iodinated resin to transfer iodine from the iodinated resin into the fluid pathway, wherein the first volume of water corresponds to an effective life of the iodinated resin; passing a second volume of water through the ion exchange resin to remove at least a portion of the iodine transferred by the iodinated resin, wherein the second volume of water corresponds to a breakthrough point as measured by iodide leakage; and passing a third volume of water through the ion exchange resin to inactivate contaminants as the iodinated resin nears the end of its effective life, wherein the third volume of water corresponds to a microbial kill effective life of the ion exchange resin.

### DESCRIPTION OF THE DRAWING FIGURES

The various embodiments described herein may be better understood by considering the following description in conjunction with the accompanying drawing FIGURE. The sizes, shapes, and relative positions of elements in the drawing FIGURE may not be drawn to scale and some of these elements may be arbitrarily enlarged and/or positioned to improve legibility.

FIG. 1 illustrates a schematic view of an embodiment of a water treatment system comprising a halogenated resin and an ion exchange resin.

### DESCRIPTION OF CERTAIN EMBODIMENTS

### A. Definitions

As generally used herein, the term “comprising” refers to various components conjointly employed in the manufacture and/or use of the water treatment systems described herein. Accordingly, the terms “consisting essentially of” and “consisting of” are embodied in the term “comprising”.

As generally used herein, the articles including “the”, “a” and “an” refer to one or more of what is claimed or described.

As generally used herein, the terms “include”, “includes” and “including” are meant to be non-limiting.

As generally used herein, the terms “have”, “has” and “having” are meant to be non-limiting.

As generally used herein, the terms “about” and “approximately” refer to an acceptable degree of error for the quantity measured, given the nature or precision of the measurements. Typical exemplary degrees of error may be within 20%, 10%, or 5% of a given value or range of values. Alternatively, and particularly in biological systems, the terms “about” and “approximately” refer to values within an order of magnitude, potentially within 5-fold or 2-fold of a given value.

All numerical quantities stated herein are approximate unless stated otherwise; meaning that the term “about” may be inferred when not expressly stated. The numerical quantities disclosed herein are to be understood as not being strictly limited to the exact numerical values recited. Instead, unless stated otherwise, each numerical value is intended to mean both the recited value and a functionally equivalent range surrounding that value. At the very least, and not as an attempt to limit the application of the doctrine of equivalents to the scope of the claims, each numerical parameter should at least be construed in light of the number of reported significant digits and by applying ordinary rounding techniques. Notwithstanding the approximations of numerical quantities stated herein, the numerical quantities described in specific examples of actual measured values are reported as precisely as possible.

All numerical ranges stated herein include all sub-ranges subsumed therein. For example, a range of “1 to 10” is intended to include all sub-ranges between and including the recited minimum value of 1 and the recited maximum value of 10. Any maximum numerical limitation recited herein is intended to include all lower numerical limitations. Any minimum numerical limitation recited herein is intended to include all higher numerical limitations.

As generally used herein, the term “contaminant” may refer to any undesirable agent in a gas, vapor, or liquid fluid or solution. “Contaminant” may include, for example, but not limited to, heavy metals, such as lead, nickel, mercury, copper, etc.; reduced forms of halogens, such as iodide, chloride, bromide; microorganisms or microbes (as well as reproductive forms of microorganisms, including cysts and spores) including viruses, such as enteroviruses (polio, Coxsackie, echovirus, hepatitis, calcivirus, astrovirus), rotaviruses and other reoviruses, adenoviruses Norwalk-type agents, Snow Mountain agent, fungi (for example, molds and yeasts); helminthes; bacteria (including salmonella, shigella, yersinia, fecal coliforms, mycobacteria, enterocolitica, E. coli, Campylobacter, Serratia, Streptococcus, Legionella, Cholera); flagellates; amoebae; Cryptosporidium, Giardia, other protozoa; prions; proteins and nucleic acids; inorganic chemicals (such as antimony, arsenic, asbestos, barium, beryllium, cadmium, chromium, copper, cyanide, fluoride, lead, mercury, nitrate, selenium, and thalium); radioactive isotopes; and certain polyvalent dissolved salts; as well as other debris.

As generally used herein, the term “log reduction value” refers to the Log₁₀ of the level of contaminants (typically the number of microorganisms) in the influent divided by the level of contaminants (typically the number of microorganisms) in the effluent of the water treatment system. For example, a log 4 reduction in contaminants is >99.99% reduction in contaminants and a log 5 reduction in contaminants is >99.999% reduction in contaminants. In at least one embodiment, the water treatment systems and methods may comprise at least a log 4 to log 5, log 5 to log 6, log 6 to log 7, log 7 to log 8, and log 8 to log 9 kill or removal of most microorganisms, potentially including viruses.

As generally used herein, the terms “removing contaminants” and “inactivating contaminants” refers to disarming one or more contaminants in the fluid, whether by physically or chemically removing, reducing, destroying, modifying, inactivating, or separating the contaminants, or otherwise rendering the one or more contaminants harmless. Certain embodiments may include removing one or more contaminants but specifically exclude one or more types, groups, categories or specifically identified contaminants as well. For example, in certain aspects, “removing contaminants” and “inactivating contaminants” may include one or more contaminants, or may include only one particular contaminant, or may specifically exclude one or more contaminants.

As generally used herein, the term “microbial kill” refers to bactericidal and virucidal properties.

As generally used herein, the term “residual iodine” refers to iodine remaining in solution. In certain embodiments, the residual iodine may range between about 0.5-4.0 mg/L.

As generally used herein, the term “sorbent media” refers to material that may absorb or adsorb at least one contaminant. In general, “absorbent” includes materials capable of drawing substances, including contaminants, into its surface or structure, whereas “adsorbent” includes materials that are capable of physically holding substances, including contaminants, on its outer surfaces.

As generally used herein, the term “breakthrough point” refers to the point when an untreated feed stream of a fluid having an original concentration of 2-4 ppm of elemental iodine and 0.1-0.5 ppm of iodide ion in dechlorinated tap water reaches a total iodine concentration of 0.05 ppm as measured by the Leuco Crystal Violet Method (American Water Works Association Standard Method 4500 for iodine and iodide).

In certain embodiments, one or more of the filter media components may be immobilized utilizing binders, matrices or other materials that hold the media components together. Some examples of binders and/or matrices include but are not limited to powdered polyethylene, end-capped polyacetals, acrylic polymers, fluorocarbon polymers, perfluorinated ethylene-propylene copolymers, ethylene-tetrafluoroethylene copolymers, polyamides, polyvinyl fluoride, polyaramides, polyaryl sulfones, polycarbonates, polyesters, polyaryl sulfides, polyolefins, polystyrenes, polymeric microfibers of polypropylene, cellulose, nylon, or any combination thereof. Some of these examples may be found in U.S. Pat. Nos. 4,828,698 and 6,959,820.

The headings provided herein are for convenience only and do not interpret or limit the scope or meaning of the claims in any manner.

In the following description, certain details are set forth in order to provide a better understanding of various embodiments of the present disclosure. However, one skilled in the art will understand that the embodiments of the present disclosure may be practiced without these details. In other instances, well-known structures and methods associated with water treatment systems and methods of making or using the same may not be shown or described in detail to avoid unnecessarily obscuring descriptions of the embodiments of the disclosure.

This disclosure describes various features, aspects, and advantages of various embodiments of water treatment systems and methods for making and using the same. It is understood, however, that this disclosure embraces numerous alternative embodiments that may be accomplished by combining any of the various features, aspects, and advantages of the various embodiments described herein in any combination or sub-combination that one of ordinary skill in the art may find useful.

### B. Halogenated Release Systems

The water treatment systems described herein may comprise point-of-use or point-of-entry water treatment systems (collectively, “POU”). A POU water treatment system usually comprises a self-contained unit that may be used by anyone who would ordinarily get water from untreated sources (such as lakes, rivers, and streams), although it may also be used for further treatment of tap water as a countertop, refrigerator or other unit. POU water treatment systems may provide safe or potable drinking water for campers, hikers, military personnel, water for emergency use during natural disasters (such as earthquakes, hurricanes and floods), as well as for people living in rural or sparsely populated regions (including those living in non-industrialized nations) who may not have access to treated or purified water. Point-of use water treatment systems may provide localized water treatment at a particular point within the home, such as filters that are attached to faucets. Point-of-entry water treatment systems may be arranged near the home water-service entry point to provide whole-house water treatment.

In certain embodiments, POU water treatment systems described herein generally relate to POU systems utilizing halogenated release systems. In at least one embodiment, the halogenated release systems may comprise a halogenated resin. In at least one embodiment, the halogenated resin may transfer an effective amount of halogens into a volume of untreated or unsanitary fluid capable of removing contaminants from the fluid upon contact between the contaminants and the halogens. In at least one embodiment, the halogenated resin may transfer an effective amount of halogens into the volume of fluid generally corresponding to an effective life of the halogenated resin. The amount of halogens released from the halogenated resin may depend on various factors, including, but not limited to, the volume of halogenated resin, the volume of fluid to be treated, as well as the characteristics of the fluid to be treated, such as the pH, temperature, level of contamination, including the amount of total dissolved solids or sediment, flow rate, etc.

In certain embodiments, the halogenated release systems may comprise at least one resin selected from the group consisting of chlorinated resins, brominated resins, and iodinated resins. In at least one embodiment, the halogenated release system may comprise an iodinated resin. In at least one embodiment, the halogenated release system may comprise low residual halogenated resins. In at least one embodiment, the halogenated release systems may comprise a low-residual iodinated resin. Examples of iodinated resins are described in U.S. application Ser. No. 11/823,804 filed on Jun. 28, 2007.

In at least one embodiment, the iodinated resin may comprise an iodinated base ion exchange resin of polyiodide anions bound to the quaternary amine fixed charges of a polymer. In at least one embodiment, the iodinated resin may comprise a Microbial Check Valve or MCV® Resin. The MCV® Resin contains an iodinated strong base ion exchange resin of polyiodide anions bound to the quaternary amine fixed positive charges of a polystyrene-divinylbenzene copolymer. Polyiodide anions may be formed in the presence of excess iodine in an aqueous solution. Water flowing through the MCV® Resin may encourage the bound polyiodide anions to release iodine into the water. The amount of iodine released into the water may be capable of removing contaminants from the water. The MCV® Resin may achieve kill over 99.9999% of bacteria (log 6 kill) and 99.99% of viruses (log 4 kill) in contaminated water.

In at least one embodiment, the iodinated resin may comprise regenerative MCV® Resins. A replacement cartridge, called regenerative MCV (“RMCV”) may utilize a packed bed of crystalline elemental iodine to produce a saturated aqueous solution that may be used to replenish depleted MCV® Resin. The RMCV may be regenerated more than 100 times. The use of a regenerative system may reduce the overall cost of operating an iodine release system and eliminate the hazards associated with chlorine.

In certain embodiments, the halogenated resin may comprise low-residual halogenated resins. As generally used herein, the term “low-residual” halogenated resin refers to a halogenated resin that may release a significantly lower level of halogens than a “classic” halogenated resin. For example, a classic iodinated resin may release 4 ppm of iodine when exposed to deionized water. In at least one embodiment, the iodine released from a low-residual iodinated resin may be less than 4 ppm of iodine. In at least one embodiment, the iodine released from a low-residual iodinated resin may range from 0.1-3 ppm. In at least one embodiment, the iodine released from a low-residual iodinated resin may range from 0.1-2 ppm. In at least one embodiment, the iodine released from a low-residual iodinated resin may range from 0.2-1 ppm. In at least one embodiment, the iodine released from a low-residual iodinated resin may range from 0.5-1 ppm. In at least one embodiment, the iodine released from a low-residual iodinated resin may range from 0.2-0.5 ppm. In at least one embodiment, the iodine released from a low-residual iodinated resin may be less than 0.2 ppm.

In certain embodiments, POU water treatment systems may comprise one or more halogenated release systems. In at least one embodiment, the one or more halogenated release systems may comprise at least one halogenated release system selected from the group consisting of halogenated release systems and low-residual halogenated release systems. In at least one embodiment, the one or more halogenated release systems may comprise at least one halogenated release system selected from the group consisting of iodinated release systems and low-residual iodinated release systems. In at least one embodiment, the one or more halogenated release systems may comprise at least one resin selected from the group consisting of halogenated resins and low-residual halogenated resins. In at least one embodiment, the one or more halogenated release systems may comprise at least one resin selected from the group consisting of iodinated resins and low-residual iodinated resins.

There are many known methods for making halogenated resins, including iodinated resins. For example, U.S. Pat. Nos. 5,980,827, 6,899,868 and 6,696,055, describe methods of making halogenated or strong base anion exchange resins for purification of fluids such as air and water. Briefly, methods for making halogenated resins may generally comprise reacting the salt form of a strong base anion exchange resin with a sufficient amount of an iodine substance absorbable by the anion exchange resin such that the anion exchange resin absorbs the iodine substance and converts the anion exchange resin to an iodinated resin. If necessary, the iodinated resin reaction may be conducted at an elevated temperature and/or elevated pressure.

### C. Halogen-Scavenger Barriers

In certain embodiments, POU water treatment systems may comprise one or more halogen-scavenger barriers. As generally used herein, the term “halogen-scavenger barriers” collectively refers to any sorbent materials that may be included in POU water treatment systems to adsorb, absorb, or convert halogens to ionic form, or the materials that may be included in POU water treatment systems other than to adsorb, absorb, or convert halogens to ionic form. Generally, but not always, absorption occurs through micropore size filtration, while adsorption occurs through electrochemical charge filtration. In some situations, it may be desirable to retain a small amount of one or more halogens in the treated fluid in order to retard or inhibit microbial growth during storage, transport, and/or dispensing of the fluid. In other situations, it may be desirable to remove or reduce the amount of halogens in the treated fluid before consumption. The amount of halogens in the treated fluid may be removed or reduced by adsorbing or absorbing the halogens, or converting the halogens to an ionic form.

In at least one embodiment, the halogen-scavenger barrier may comprise one or more sorbent media. In at least one embodiment, water treatment systems may comprise two sorbent media in which the first sorbent media may comprise a first material and the second sorbent media may comprise a second material. In certain aspects, if more than one sorbent media is included, the same or multiple different sorbent media may be considered for each one. In certain embodiments, if more than one sorbent media is included, the sorbent media may be physically or chemically separated from each other, or they may be physically or chemically joined with each other.

The sorbent materials comprising halogen-scavenger barriers may include any material(s) known or unknown in the art that may be used to absorb or adsorb at least one contaminant and/or at least one halogen. Such materials may include, for example, but are not limited to, carbon or activated carbon and ion exchange resins, including anion exchange resins and more particularly strong-base anion exchange resins, such as Iodosorb®, commercially available from Water Security Corporation, Sparks, Nev., as described in U.S. Pat. No. 5,624,567. In at least one embodiment, the halogen-scavenger barrier may comprise a sorbent media comprising an ion exchange resin. In at least one embodiment, the halogen-scavenger barrier may comprise a sorbent media comprising an anion exchange resin. In at least one embodiment, the halogen-scavenger barrier may comprise a sorbent media comprising a strong-base anion exchange resin. In at least one embodiment, the halogen-scavenger barrier may comprise a sorbent media comprising Iodosorb®. Briefly, Iodosorb®, sometimes referred to as an iodine scrubber, comprises trialkyl amine groups each comprising alkyl groups containing 3 to 8 carbon atoms which may be capable of removing halogens, including iodine and/or iodide, from fluids such as aqueous solutions. In at least one embodiment, the ion exchange resin may comprise trialkyl amine groups each comprising alkyl groups containing from 3 to 8 carbon atoms.

### D. Fluid Treatment Systems

The POU water treatment systems described herein generally relate to devices capable of removing contaminants from a fluid, such as a liquid, for example, water. In certain embodiments, the water treatments systems may be used to purify drinking water, such as water for consumption in public locations, such as hotels, restaurants, aircraft or spacecraft, ships, trains, schools, hospitals, etc.; water for consumption in private locations, such as homes, apartment complexes, etc.; water in rivers, lakes, streams or the like, standing water or runoff, seawater; water for recreational purposes, such as water for swimming pools, hot tubs, and spas; water for medical procedures in hospitals and dental offices; and water used in industry.

According to certain embodiments, the water treatment system may generally comprise a halogenated resin, including any of the iodinated resins described herein, and a halogen-scavenger barrier, including any of the ion exchange resins described herein. In certain embodiments, POU water treatment systems may comprise one or more halogen-scavenger barriers and one or more halogenated release systems. In at least one embodiment, the one or more halogenated release systems and the one or more halogen-scavenger barriers may comprise the same or different halogen-scavenger barriers for each of the halogenated release systems. In at least one embodiment, POU water treatment systems may comprise one or more halogen-scavenger barriers, one or more halogenated release systems, and one or more sorbent media.

According to certain embodiments, the iodinated resin may transfer an effective amount of iodine into the untreated or unsanitary fluid passing therethrough capable of removing contaminants in the fluid. In at least one embodiment, the ion exchange resin may remove at least a portion the iodine transferred by the iodinated resin into the fluid pathway. The portion of iodine removed by the ion exchange resin may be capable of removing and/or inactivating contaminants after the iodinated resin stops transferring an effective amount of iodine into the fluid passing therethrough. In at least one embodiment, the portion of the iodine removed by the ion exchange resin may improve the filtration capacity of the water treatment system. In at least one embodiment, the portion of the iodine removed by the ion exchange resin may increase the filtration capacity of the water treatment system beyond the effective life of the iodinated resin. In at least one embodiment, the portion of the iodine removed by the ion exchange resin may increase the filtration capacity of the water treatment system after the amount of the iodine in the iodinated resin is depleted. In at least one embodiment, the portion of the iodine removed by the ion exchange resin may increase the operating time of the water treatment system. In at least one embodiment, the portion of the iodine removed by the ion exchange resin may decrease the replacement frequency of the halogenated release system.

In at least one embodiment, low pressure POU water treatment systems may generally comprise at least one inlet port in fluid communication with at least one outlet port to define a fluid pathway therethrough; an iodinated resin intermediate the at least one inlet port and the at least on outlet port, wherein the iodinated resin transfers iodine into the fluid pathway for a volume of water corresponding to an effective life of the iodinated resin; and an ion exchange resin intermediate the iodinated resin and the at least one outlet port, wherein the ion exchange resin removes at least a portion of the iodine transferred by the iodinated resin into the fluid pathway for a volume of water corresponding to a breakthrough point as measured by iodide leakage; and wherein the ion exchange resin inactivates contaminants in the fluid pathway as the iodinated resin nears the end of its effective life.

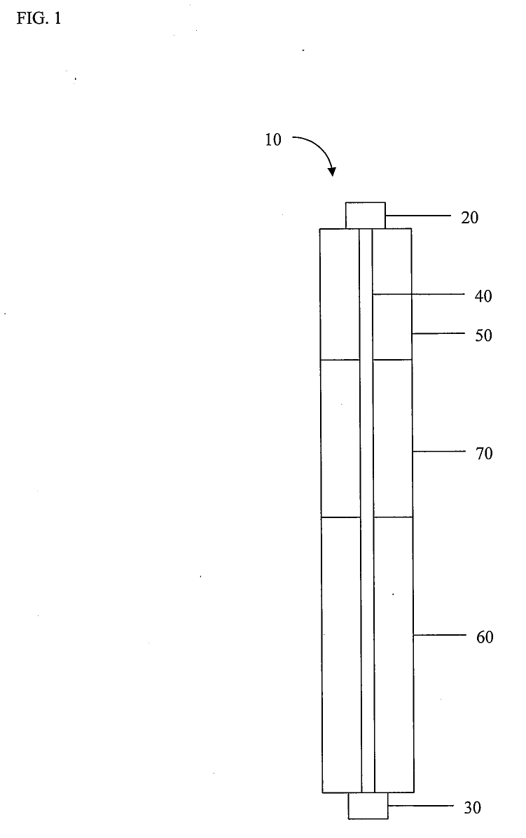

Referring to FIG. 1, according to certain embodiments, POU water treatment systems may generally comprise a reservoir 10 comprising at least one inlet port 20 in fluid communication with at least one outlet port 30 to define a fluid pathway 40 therethrough, an iodinated resin 50 intermediate the at least one inlet port 20 and the at least one outlet port 30, and an ion exchange resin 60 intermediate the iodinated resin 50 and the at least one outlet port 30. In at least one embodiment, the inlet port 20 may be adjacent the iodinated resin 50 and the outlet port 30 may be adjacent the ion exchange resin 60. In at least one embodiment, the influent may enter the reservoir 10 via the inlet port 20 and the effluent may exit the reservoir 10 via the outlet port 30. In at least one embodiment, the fluid may flow from the iodinated resin 50 to the ion exchange resin 60. The fluid pathway 40 generally refers to the fluid traversing the water treatment system, including fluid traversing the iodinated resin 50 and ion exchange resin 60. In at least one embodiment, the iodinated resin 50 may be in direct fluid communication with the ion exchange resin 60. In at least one embodiment, at least one sorbent media (not shown) may be intermediate the iodinated resin 50 and the ion exchange resin 60. In at least one embodiment, at least one sorbent media (not shown) may be intermediate the ion exchange resin 60 and the at least one outlet port 30.

In certain embodiments, a chamber 70 may be positioned intermediate the iodinated resin 50 and ion exchange resin 60. In at least one embodiment, the chamber 70 may define a gap between the iodinated resin 50 and ion exchange resin 60. In at least one embodiment, the chamber 70 may comprise an unobstructed portion of the fluid pathway 40. In at least one embodiment, the chamber 70 may comprise a sorbent material. In at least one embodiment, the fluid may flow from the iodinated resin 50 to the chamber 70 and from the chamber 70 to the ion exchange resin 60. In at least one embodiment, the chamber 70 increases the time that the halogens and fluid remain in contact. In at least one embodiment, the chamber 70 may improve the microbial kill.

In certain embodiments, the reservoir 10 may further comprise a housing (not shown) such that the fluid pathway 40 may be positioned along the longitudinal axis of the housing (not shown). In at least one embodiment, at least one of the ports 20, 30, iodinated resin 50, chamber 70, and ion exchange resin 60 may be axially spaced along the fluid pathway 40. The housing (not shown) may comprise any suitable material, such as, for example, but not limited to, glass, metal, ceramic, plastic, etc. The housing (not shown) may comprise any suitable shape, such as, for example, but not limited to, cylindrical and rectangular.

In at least one embodiment, the iodinated resin may comprise at least one resin selected from the group consisting of iodinated resins and low residual iodinated resins. In at least one embodiment, the iodinated resin may comprise an iodinated base ion exchange resin of polyiodide anions bound to the quaternary amine fixed charges of a polymer. In at least one embodiment, the iodinated resin may comprise a Microbial Check Valve or MCV® Resin.

In at least one embodiment, the iodinated resin may transfer iodine into the fluid passing therethrough. In at least one embodiment, the iodinated resin may transfer iodine into a volume of water generally corresponding to an effective life of the iodinated resin. The volume of water may be pre-calculated to correlate to the minimum safe volume of water that the halogenated release system comprising the iodinated resin may be capable of treating under the harshest predicted operating environment. This predetermined volume may be referred to as the “effective life” of the iodinated resin. The effective life of halogen release systems may be readily ascertained by methods well known to the skilled artisan, such as, techniques used to predict when a halogenated release system should be replaced. For example, water treatment systems may include a mechanical indicator, such as a flow meter, to measure the volume of fluid passing through the halogenated release system, or the halogenated release system may comprise a halogen-scavenger bather that progressively changes color or provides other visual indicia as iodine is absorbed from the fluid. These techniques may only provide an estimate of the amount of halogens actually remaining in the halogenated release system, based on, for example, temperature, pH, etc. These techniques may also indicate when a predetermined volume of water has passed through the water treatment system.

In certain embodiments, the water treatment system may comprise a halogen scavenger barrier. In at least one embodiment, the halogen scavenger barrier may comprise an ion exchange resin. In at least one embodiment, the ion exchange resin may comprise trialkyl amine groups each comprising alkyl groups containing from 3 to 8 carbon atoms. In at least one embodiment, the ion exchange resin may comprise Iodosorb®.

In at least one embodiment, the ion exchange resin may remove at least a portion of the iodine transferred by the iodinated resin into the fluid pathway from a volume of water corresponding to a breakthrough point as measured by iodide leakage. As generally used herein, the term “breakthrough point” of the ion exchange resin refers to the volume of fluid passing through the ion exchange resin needed to go beyond the adsorption capacity of the ion exchange resin. The breakthrough point may be determined by measuring iodide leakage. The breakthrough point may be defined as the point when an untreated feed stream, which originally contained 2-4 ppm of elemental iodine and 0.1-0.5 ppm of iodide ion in dechlorinated tap water, traverses the water treatment system and reaches a total iodine concentration of 0.05 ppm as measured by the Leuco Crystal Violet Method (American Water Works Association Standard Method 4500 for iodine and iodide). The iodide leakage may be readily ascertained by methods well known to the skilled artisan, such as, for example, colorimetric analyses using pocket colorimeters available from the Hach Company, Loveland, Colo. In at least one embodiment, the effectiveness of the ion exchange resin to remove iodine from the fluid pathway may be characterized by measuring iodide leakage generally corresponding to a breakthrough point.

In certain embodiments, the ion exchange resin may remove at least a portion of the iodine transferred by the iodinated resin into the fluid pathway. In at least one embodiment, the iodinated resin may transfer an amount of iodine into the fluid pathway such that the ion exchange resin removes at least a portion of elemental iodine (I₂), iodide ions (HOI and I⁻), or any mixture thereof. In at least one embodiment, the ion exchange resin may remove substantially all of the iodine transferred by the iodinated resin into the fluid pathway. In at least one embodiment, the ion exchange resin may treat the fluid eluting from the halogenated resin including elemental iodine and iodide ions by removing elemental iodine and iodide ions therefrom. In general, the higher the amount of ion exchange resin used in the water treatment system and the longer the time period for a fluid to reach a given level of I₂ and I⁻, the more effective the ion exchange resin may be in removing these moieties from the fluid.

In at least one embodiment, the ion exchange resin may remove substantially all of the iodine transferred by the iodinated resin into the fluid pathway such that the effluent is free from iodine. In at least one embodiment, the ion exchange resin may remove substantially all of the iodine transferred by the iodinated resin into the fluid pathway such that the effluent is mostly free from iodine. In at least one embodiment, the ion exchange resin may remove substantially all of the iodine transferred by the iodinated resin into the fluid pathway such that the effluent is substantially free from iodine. In at least one embodiment, the ion exchange resin may remove substantially all of the iodine transferred by the iodinated resin into the fluid pathway such that the effluent is completely free from iodine.

In at least one embodiment, the ion exchange resin may remove the iodine transferred by the iodinated resin into the fluid pathway to reach the breakthrough point. In at least one embodiment, the ion exchange resin may remove the iodine transferred by the iodinated resin into the fluid pathway without reaching the breakthrough point. In at least one embodiment, the volume of the fluid contacting the ion exchange resin before reaching the breakthrough point may be at least 8 liters per cubic centimeter. In at least one embodiment, the volume of the fluid contacting the ion exchange resin before reaching the breakthrough point may be at least 10 liters per cubic centimeter. In at least one embodiment, the volume of the fluid contacting the ion exchange resin before reaching the breakthrough point may be at least 16 liters per cubic centimeter. In at least one embodiment, the volume of the fluid contacting the ion exchange resin before reaching the breakthrough point may be 8-16 liters per cubic centimeter. A person of ordinary skill in the art would understand that the volume of the fluid contacting the ion exchange resin before it reaches the breakthrough point may vary depending on various factors, e.g., the specific configuration of the water treatment system.

In certain embodiments, the ion exchange resin may remove contaminants and/or inactivate contaminants in the fluid pathway as the iodinated resin nears the end of its effective life. In at least one embodiment, the ion exchange resin may remove contaminants and/or inactivate contaminants in the fluid pathway after the iodinated resin reaches the end of its effective life. In at least one embodiment, the ion exchange resin may remove contaminants and/or inactivate contaminants in the fluid pathway after the iodinated resin reaches the end of its effective life but before the ion exchange resin reaches the breakthrough point.

In at least one embodiment, the ion exchange resin may remove contaminants and/or inactivate contaminants in the fluid pathway as the concentration of iodine in the iodinated resin becomes depleted. In at least one embodiment, the ion exchange resin may remove contaminants and/or inactivate contaminants in the fluid pathway as the concentration of iodine in the iodinated resin becomes mostly depleted. In at least one embodiment, the ion exchange resin may remove contaminants and/or inactivate contaminants in the fluid pathway as the concentration of iodine in the iodinated resin becomes substantially depleted. In at least one embodiment, the ion exchange resin may remove contaminants and/or inactivate contaminants in the fluid pathway after the concentration of iodine in the iodinated resin is depleted.

In certain embodiments, the portion of the iodine removed by the ion exchange resin from the fluid pathway may inactivate contaminants in the fluid pathway as the iodinated resin nears the end of its effective life. In at least one embodiment, the portion of the iodine removed by the ion exchange resin from the fluid pathway may inactivate contaminants in the fluid pathway after the iodinated resin reaches the end of its effective life. In at least one embodiment, the portion of the iodine removed by the ion exchange resin from the fluid pathway may inactivate contaminants in the fluid pathway after the iodinated resin reaches the end of its effective life but before the ion exchange resin reaches the breakthrough point.

In at least one embodiment, the portion of the iodine removed by the ion exchange resin from the fluid pathway may inactivate contaminants in the fluid pathway as the concentration of iodine in the iodinated resin becomes depleted. In at least one embodiment, the portion of the iodine removed by the ion exchange resin from the fluid pathway may inactivate contaminants in the fluid pathway as the concentration of iodine in the iodinated resin becomes mostly depleted. In at least one embodiment, the portion of the iodine removed by the ion exchange resin from the fluid pathway may inactivate contaminants in the fluid pathway as the concentration of iodine in the iodinated resin becomes substantially depleted. In at least one embodiment, the portion of the iodine removed by the ion exchange resin from the fluid pathway may inactivate contaminants in the fluid pathway after the concentration of iodine in the iodinated resin is depleted.

In certain embodiments, the ion exchange resin may remove contaminants and/or inactivate contaminants from a volume of water in the fluid pathway corresponding to a breakthrough point as measured by iodide leakage. In at least one embodiment, the ion exchange resin may adsorb contaminants from a volume of water generally corresponding to a microbial kill effective life of the ion exchange resin. In at least one embodiment, the microbial kill effective life of the ion exchange resin may increase as the effective life of the iodinated resin decreases. In at least one embodiment, the microbial kill effective life of the ion exchange resin may increase as the concentration of iodine in the iodinated resin decreases. In at least one embodiment, the microbial kill effective life of the ion exchange resin may increase as the ion exchange resin nears the breakthrough point. In at least one embodiment, the microbial kill effective life of the ion exchange resin may increase by removing the iodine transferred by the iodinated resin into the fluid pathway.

In at least one embodiment, the microbial kill effective life of the ion exchange resin may increase the filtration capacity of the water treatment system. The volume of water correlating to the minimum safe volume of water that the POU water treatment system may be capable of treating under the harshest predicted operating environment may be referred to as the “filtration capacity” or “microbial inactivation capacity”. In at least one embodiment, the microbial kill effective life of the ion exchange resin may substantially increase the filtration capacity of the water treatment system. In at least one embodiment, the microbial kill effective life of the ion exchange resin may increase the filtration capacity of the water treatment system beyond the effective life of the iodinated resin. In at least one embodiment, the microbial kill effective life of the ion exchange resin may increase the filtration capacity of the water treatment system to the breakthrough point. In at least one embodiment, the microbial kill effective life of the ion exchange resin may increase the filtration capacity of the water treatment system beyond the breakthrough point.

### E. Low Pressure Fluid Treatment Systems

In certain embodiments, the water treatment system may comprise a low pressure POU water treatment system. In at least one embodiment, the low pressure water treatment system may operate at a pressure ranging from 0.1-10 psi. In at least one embodiment, the low pressure water treatment system may operate at a pressure less than 10 psi. In at least one embodiment, the water treatment system may comprise a pressurized POU water treatment system such that the fluid is forced through the water treatment system by system pressure. In at least one embodiment, POU water treatment systems may comprise a reservoir conFIGUREd to take advantage of gravity. For example, the shape and size of the reservoir may be of any dimensions to accommodate the desired capacity, pressure, and flow rate through the water treatment system. In at least one embodiment, POU water treatment systems may be conFIGUREd such that the force of gravity encourages fluid in the fluid pathway to flow from the halogenated resin to the halogen-scavenger barrier. In at least one embodiment, the fluid pathway may be conFIGUREd to encourage fluid to flow from the halogenated resin to the halogen-scavenger barrier by a gravity feed.

In certain embodiments, POU water treatment systems may comprise a low flow water treatment system. In at least one embodiment, the flow rate of the low pressure POU water treatment system may range from 150 mL/min to 250 mL/min under ambient pressure and gravity.

In at least one embodiment, POU water treatment systems may comprise a water treatment system that does not require electricity or power sources to operate. In at least one embodiment, the POU water treatment system may be powered by gravity. In at least one embodiment, the POU water treatment system may be powered by gravitational flow.

### F. Methods of Use

In certain embodiments, a method may generally comprise providing a low pressure point-of-use water treatment system having a microbial inactivation capacity, the water treatment system comprising at least one inlet port in fluid communication with at least one outlet port to define a fluid pathway therethrough; an iodinated resin intermediate the at least one inlet port and at least on outlet port; and an ion exchange resin intermediate the iodinated resin and the at least one outlet port; introducing water into the at least one inlet port; passing a first volume of water through the iodinated resin to transfer iodine from the iodinated resin into the fluid pathway, wherein the first volume of water corresponds to an effective life of the iodinated resin; passing a second volume of water through the ion exchange resin to remove at least a portion of the iodine transferred by the iodinated resin, wherein the second volume of water corresponds to a breakthrough point as measured by iodide leakage; and passing a third volume of water through the ion exchange resin to inactivate contaminants as the iodinated resin nears the end of its effective life, wherein the third volume of water corresponds to a microbial kill effective life of the ion exchange resin.

In at least one embodiment, passing a second volume of water through the ion exchange resin to remove at least a portion of the iodine may comprise removing substantially all of the iodine from the fluid pathway. In at least one embodiment, passing a second volume of water through the ion exchange resin to remove at least a portion of the iodine may comprise removing substantially all of the iodine from the fluid pathway such that the effluent is free, mostly free, substantially free, or completely free of iodine. In at least one embodiment, passing a second volume of water through the ion exchange resin to remove at least a portion of the iodine may comprise removing iodine selected from the group consisting of I₂, I⁻, and any mixture thereof.

In at least one embodiment, the method may comprise passing the third volume of water through the ion exchange resin to inactivate contaminants after the effective life of the iodinated resin. In at least one embodiment, the method may comprise passing a third volume of water through the ion exchange resin to inactivate contaminants after the effective life of the iodinated resin but before the ion exchange resin reaches the breakthrough point. In at least one embodiment, passing a third volume of water through the ion exchange resin to inactivate contaminants may comprise contacting contaminates with iodine selected from the group consisting of I₂, I⁻, and any mixture thereof. In certain embodiments, the first volume of water, second volume of water, and third volume of water may each be the same or different.

According to certain embodiments, passing the third volume of water through the ion exchange resin to inactivate contaminants, may comprise adsorbing contaminants. In at least one embodiment, the microbial kill effective life of the ion exchange resin may increase as the effective life of the iodinated resin decreases. In at least one embodiment, the microbial kill effective life of the ion exchange resin may increase as the ion exchange resin nears the breakthrough point. In at least one embodiment, removing at least a portion of the iodine may increase the microbial kill effective life of the ion exchange resin. In at least one embodiment the method may comprise increasing the microbial inactivation capacity by increasing the microbial kill effective life of the ion exchange resin. In at least one embodiment the method may comprise increasing the inactivation of contaminants as the concentration of iodine in the iodinated resin becomes substantially depleted. In at least one embodiment, comprising increasing the microbial inactivation capacity beyond the effective life of the ion exchange resin by increasing the microbial kill effective life of the ion exchange resin.

### G. Kits

In certain embodiments, POU water treatment systems may further comprise kits generally relating to any of the compositions, apparatuses, systems and/or methods described herein.

### H. Examples

The various embodiments described herein may be better understood when read in conjunction with the following representative example. The following example is included for purposes of illustration and not limitation.

A challenge experiment may be used to determine the ability of a POU water treatment system to remove contaminants. For example, a challenge, or a known quantity of a selected microbiological contaminant, may be added to the water entering the water treatment system. The amount of the contaminant in the water entering and exiting the system may be measured to determine the filtration capacity or microbial inactivation capacity of the water treatment system.

The virus MS2 coliphage may be chosen as the surrogate test organism. MS2 coliphage is a virus that infects E. coli ACTT 15597. The water entering and exiting the water treatment system are tested for MS2 coliphage. A 2-3 log inactivation of MS2 may represent a 5-6 log inactivation of coliform bacteria in iodinated POU water treatment systems.

A certain embodiment of the POU water treatment system described herein is tested for its ability to remove contaminants from an untreated or unsanitary fluid. In particular, approximately 5 log PFU/mL of MS2 in 2880 mL de-chlorinated tap water at room temperature is introduced to the water treatment system via the inlet port and contacts a MCV® iodinated resin (approximately 35 mL) and subsequently passes through an Iodosorb® ion exchange resin (approximately 250 mL), and is dispensed through the outlet port. Testing for contaminants is conducted after contact with the MCV® iodinated resin and after contact with the Iodosorb® ion exchange resin. The column diameter is 54 mm. The flow-rate is 240 mL/min. The results of the testing are shown in TABLE 1.

TABLE 1

| | | | Effluent MS2 (Log PFU/ml) | | | |
|---|---|---|---|---|---|---|
| | | Influent | | Log | | Log |
| Feed | | MS2 | | removal | | removal |
| Volume | Resin | (Log | | (Log | | (Log |
| (L) | Type | PFU/mL) | Resin | PFU/mL) | Iodosorb | PFU/mL) |
| 3000 | MCV | 5.58 | 3.14 | 2.43 | 1.70 | 3.88 |

All documents cited herein are, in relevant part, incorporated herein by reference, but only to the extent that the incorporated material does not conflict with existing definitions, statements, or other documents set forth herein. To the extent that any meaning or definition of a term in this document conflicts with any meaning or definition of the same term in a document incorporated by reference, the meaning or definition assigned to that term in this document shall govern. The citation of any document is not to be construed as an admission that it is prior art with respect to the present invention.

While particular embodiments of water treatment systems have been illustrated and described, it would be obvious to those skilled in the art that various other changes and modifications can be made without departing from the spirit and scope of the invention. Those skilled in the art will recognize, or be able to ascertain using no more than routine experimentation, numerous equivalents to the specific apparatuses and methods described herein, including alternatives, variants, additions, deletions, modifications and substitutions. This disclosure including the appended claims is therefore intended to cover all such changes and modifications that are within the scope of this invention.

What is claimed is:

1. A low pressure point-of-use water treatment system comprising:
at least one inlet port in fluid communication with at least one outlet port to define a fluid pathway therethrough;
an iodinated resin intermediate the at least one inlet port and the at least one outlet port, wherein the iodinated resin transfers iodine into the fluid pathway for a volume of water corresponding to an effective life of the iodinated resin; and
an ion exchange resin intermediate the iodinated resin and the at least one outlet port, wherein the ion exchange resin removes at least a portion of the iodine transferred by the iodinated resin into the fluid pathway for a volume of water corresponding to a breakthrough point as measured by iodide leakage; and
wherein the ion exchange resin inactivates contaminants in the fluid pathway as the iodinated resin nears the end of its effective life.

2. The water treatment system of claim 1, wherein the ion exchange resin adsorbs contaminants from a volume of water corresponding to a microbial kill effective life of the ion exchange resin.

3. The water treatment system of claim 2, wherein the microbial kill effective life of the ion exchange resin increases as the effective life of the iodinated resin decreases.

4. The water treatment system of claim 2, wherein the microbial kill effective life of the ion exchange resin increases as the ion exchange resin nears the breakthrough point.

5. The water treatment system of claim 1, wherein the portion of the iodine removed by the ion exchange resin is selected from the group consisting of I₂, I⁻, and any mixture thereof.

6. The water treatment system of claim 5, wherein the portion of iodine removed by the ion exchange resin inactivates contaminants in the fluid pathway.

7. The water treatment system of claim 1, wherein the ion exchange resin inactivates contaminants in the fluid pathway as the concentration of iodine in the iodinated resin becomes substantially depleted.

8. The water treatment system of claim 1, wherein the ion exchange resin inactivates contaminants in the fluid pathway after the concentration of iodine in the iodinated resin is depleted but before the ion exchange resin reaches the breakthrough point.

9. The water treatment system of claim 1, wherein the water treatment system has a microbial inactivation capacity, and the portion of iodine removed by the ion exchange resin increases the microbial inactivation capacity beyond the effective life of the iodinated resin.

10. The water treatment system of claim 1, wherein the pressure is less than 10 psi.

11. The water treatment system of claim 1, wherein the water treatment system is powered by gravitational flow.

12. A method comprising:
providing a low pressure point-of-use water treatment system having a microbial inactivation capacity, the water treatment system comprising at least one inlet port in fluid communication with at least one outlet port to define a fluid pathway therethrough, an iodinated resin intermediate the at least one inlet port and the at least one outlet port, and an ion exchange resin intermediate the iodinated resin and the at least one outlet port;
introducing water into the at least one inlet port;
passing a first volume of water through the iodinated resin to transfer iodine from the iodinated resin into the fluid pathway, wherein the first volume of water corresponds to an effective life of the iodinated resin;
passing a second volume of water through the ion exchange resin to remove at least a portion of the iodine transferred by the iodinated resin, wherein the second volume of water corresponds to a breakthrough point as measured by iodide leakage; and
passing a third volume of water through the ion exchange resin to inactivate contaminants as the iodinated resin nears the end of its effective life, wherein the third volume of water corresponds to a microbial kill effective life of the ion exchange resin.

13. The method of claim 12 comprising passing the third volume of water through the ion exchange resin to inactivate contaminants after the effective life of the iodinated resin.

14. The method of claim 12 comprising passing the third volume of water through the ion exchange resin to inactivate contaminants after the iodine in the iodinated resin is depleted.

15. The method of claim 12 comprising passing the third volume of water through the ion exchange resin to inactivate contaminants after the iodine in the iodinated resin is depleted but before the ion exchange resin reaches the breakthrough point.

16. The method of claim 12, wherein the microbial kill effective life of the ion exchange resin increases as the effective life of the iodinated resin decreases.

17. The method of claim 12, wherein the microbial kill effective life of the ion exchange resin increases as the ion exchange resin nears the breakthrough point.

18. The method of claim 12, wherein removing at least a portion of the iodine increases the microbial kill effective life of the ion exchange resin.

19. The method of claim 12, comprising increasing the microbial inactivation capacity beyond the effective life of the ion exchange resin by increasing the microbial kill effective life of the ion exchange resin.

20. The method of claim 12, wherein passing a third volume of water through the ion exchange resin to inactivate contaminants comprises contacting the contaminates with iodine selected from the group consisting of I₂, I⁻, and any mixture thereof.
